(19) United States
(12) Patent Application Publication
(10) Pub. No.: US 2019/0178330 A1
(43) Pub. Date: Jun. 13, 2019

(54) DEVICE FOR SUSPENDING A LOAD IN A VIBRATION-INSULATED MANNER

(71) Applicant: Technische Universität Wien, Wien (AT)

(72) Inventors: Michael Schmid, Wien (AT); Martin Setvin, Wien (AT); Ulrike Diebold, Wien (AT)

(21) Appl. No.: 16/327,528

(22) PCT Filed: Aug. 25, 2017
(86) PCT No.: PCT/EP2017/071401

§ 371 Date: Feb. 22, 2019

(30) Foreign Application Priority Data
Aug. 26, 2016 (AT) A 50765/2016

(51) Int. Cl. F16F 15/04; F16F 1/12

(52) U.S. Cl. CPC F16F 15/04; F16F 1/121

(57) ABSTRACT

The invention relates to a device for suspending a load (10) on at least one support element (1) in a vibration-insulated manner, said device comprising a main part (2) for receiving the load (10). The main part (2) has multiple securing regions (3a, 3b) for securing elastic elements (4a, 4b, 4c, 4d, 4e). Each of the elastic elements (4a, 4b, 4c, 4d, 4e) has a first end region (6) and is second end region (7), and the first end regions (6) of the elastic elements are secured to the main part (2). The second end region (7) is provided for connecting to the at least one support element (1). According to the invention, a regulating and control unit and at least one actuator (8) are provided in order to regulate a preferably specifiable position of the main part (2) and/or the load (10) in an operational state of the device, and the at least one actuator (8) is operatively connected to the second end region (7) of at least one elastic element (4c) in order to be able to adjust the vertical position (9) of the second end region (7) of the at least one elastic element (4e).

### FIELD OF THE INVENTION

This invention concerns a device for vibration-isolated suspension of a load on at least one support element, the device comprising a base element for accepting the load, where the base element comprises a plurality of attachment regions for attachment of elastic elements, where each of the elastic elements has a first end region and a second end region and is attached to the base element by the first end region, where the second end region of the relevant elastic element is provided for its attachment to the at least one support element.

### PRIOR ART

There are many applications, especially in the field of research and development, in which equipment must be operated without troublesome vibrations or oscillations as far as possible. For example, vibration isolation of high-resolution electron microscopes, scanning probe microscopes, optical tables, or nanotechnology equipment is a common problem. In this case, the equipment must be isolated from the vibrations of the relevant support structure, for example the building in which the particular apparatus is located.

The performance of the vibration isolation is characterized here by the ratio of the amplitudes of the vibrations above the load, i.e., the relevant apparatus, to the amplitudes of the vibrations of the support structure as a function of frequency. For systems that essentially operate as (vertical) spring-mass systems or (horizontal) pendulum systems, the performance of the vibration isolation at low frequencies is mainly dependent on the relevant resonance frequency, which should be as low as possible.

From the prior art, various types of vibration isolation are known for applications that require maximum performance. The three most important will be noted here briefly.

One type consists of pneumatic systems, in which the load is ultimately supported at three or more points by membranes pressurized with air. Typically, resonance frequencies of minimally 2 Hz can be achieved in this way, while in rare cases the resonance frequency can be pushed down to 1.5 Hz or even smaller values. A level control, which in particular enables the load to be kept horizontal, is possible through controllable valves to regulate the air pressure.

One possibility for achieving lower resonance frequencies is suspension of the load on relatively soft elastic elements, in particular rubber cords. A level control or position control is not known here, so that a change of the distribution of the weight of the load will inevitably lead to a change of position or to a tipping of the load. Furthermore, unavoidable aging phenomena of elastic elements or rubber cords also lead to such changes of position. In particular, the handling of heavy loads is thus extremely limited, since this type of vibration isolation can only be used for loads of a maximum of about 100 kg.

Finally, there is active vibration isolation, in which accelerations of the support structure and/or the load are measured. The measured accelerations are counteracted by means of actuators by which the load is supported. The performance of these systems, however, is limited at low frequencies by noise or by the sensitivity of the available acceleration sensors. Furthermore, the control of the actuators is complicated and must be adjusted every time for different loads. Moreover, in practice there are often also problems at higher frequencies of about 10 Hz to 20 Hz, which are related to the substrate on which the vibration isolation is built. Level control is basically possible with these systems, for example by means of pneumatic elements.

### AIM OF THE INVENTION

It is therefore the aim of this invention to make available a device for vibration isolation that avoids said disadvantages. The device according to the invention is intended to be designed in particular for lo resonance frequencies, to enable level control or horizontal stability of the load, and to allow large loads.

### PRESENTATION OF THE INVENTION

To solve said problem in the case of a device for vibration-isolated suspension of a load on at least one support element, the device comprising a base element for accepting the load, where the base element comprises a plurality of attachment regions for attachment of elastic elements, where each of the elastic elements has a first end region and a second end region and is attached by the first end region to the base element, where the second end region of the relevant elastic element is provided to attach it to the at least one support element, according to the invention it is provided that a regulating and control unit and at least one actuator are provided, in order to control a position, preferably a settable position, of the base element and/or the load in an operating state of the device, where the at least one actuator is operatively connected to the second end region of at least one elastic element, so as to be able to adjust a vertical position of the second end region of said at least one elastic element.

Here and below, “position” is understood to mean the orientation or alignment and/or a height with respect to a reference, for example with respect to at least one fixed point or a floor.

The at least one support element can, for example, be formed directly by a ceiling of a space in which the device according to the invention is operated, or by one or more supports, which in turn are mounted on the ceiling. Furthermore, the at least one support element can, for example, be formed by one or more anchor points or by a special support structure on which the device can be suspended, where the support structure can, for example, be situated on the floor of the space.

The base element is a mount for the load. Typically, the load can be attached to the base element in order to guarantee a reliable support of the load on the base element.

The base element can, for example, be made in the form of a suitable frame or a platform, which enables the acceptance or securing of various loads. Of course, the frame or platform can also be designed specifically for the load that is to be accepted and matched to it in shape and/or dimensions.

Typically, the load is separably attached to the base element. However, it is also conceivable that the base element is connected to the load at least partly inseparably, for example by welding.

The base element can also consist of a plurality of separate parts, which, for example, are attached to different sides of the load and together form the base element.

In a preferred embodiment of the device according to the invention, it is provided that a group that comprises a plurality of elastic elements is provided for each attachment region in order to connect the relevant attachment region to the at least one support element, and that the at least one actuator is operatively connected to the second end region of at least one elastic element of at least one of the groups.

By providing a group with a plurality of elastic elements for each attachment region, each individual elastic element can in and of itself be made very soft, which simplifies installation, in particular when each of the elastic elements can be tensioned by hand. In addition, very cheap standard parts can be used as elastic elements. Thus, overall a dimensioning even for very large loads over 1000 kg is possible without any problem, and very low resonance frequencies of under 1 Hz can be achieved. For example, with rubber cords about 2 m long as elastic elements, [resonance frequencies of] around 0.8 Hz can typically be achieved.

The at least one actuator creates the possibility of actively influencing the position or orientation and level of the load. In turn, the use of a plurality of elastic elements per attachment region or per group has an advantageous effect, since all of the elastic elements do not necessarily have to be moved by the at least one actuator in order to bring about a change of position. Typically, a few elastic elements per group can be directly connected to the at least one support element, i.e., said elastic elements—also called “fixed elastic elements” in what follows—connect the relevant attachment region directly to the at least one support element. To regulate the position, only the remaining elastic elements—also called “movable elastic elements” in what follows—of the relevant group are used. The actuator can be dimensioned to be correspondingly low-power, which again saves costs.

Moreover, experience indicates that these comparable small or low-power actuators themselves give rise to less vibration than larger or more powerful actuators.

Finally, less force is transmitted to the base element or the load by one elastic element alone or by a few small elastic elements than by a plurality of elastic elements. Thus, said embodiment allows a clear reduction of the vibrations transmitted to the load by the at least one actuator.

Typically, the device is designed with respect to the desired load so that the fixed elements alone are just insufficient to support the load or to suspend the load. Thus, just with the fixed elements by themselves, the base element with the engaged load, in the operating state, would not lift up from the floor or other fixed points on which the base element lies. Only through the additional elastic force of the one movable element or the plurality of movable elements will the weight of the load and base element be overcome and actual suspension of the load can take place in the operating state. By the vertical position of the second end region of the at least one movable elastic element then being lifted or lowered by the at least one actuator, the base element together with the load will be lifted or lowered in the region of the relevant attachment region.

Correspondingly, in a preferred embodiment of the device according to the invention, it is provided that at least for one, preferably for at least three, especially preferably for each one of the groups, that a number of the elastic elements of said group that are operatively connected to the at least one actuator is less than a total number of the elastic elements of said group.

It is provided in an especially preferred embodiment of the device according to the invention that the number is a maximum of one. As noted, this is possible since the individual elastic element that can be moved by the actuator only needs to accept a relatively small weight and thus—just like the associated actuator—can correspondingly be dimensioned to be low-powered. The manufacturing expense, the technical complexity, and the costs of the device are thus dramatically reduced.

Basically, it is also conceivable that there are one or more groups that have only fixed elastic elements and thus do not have a movable elastic element. For said group(s), the number is, correspondingly, zero.

So as not to enable a one-sided tipping of the load, rather preferably in fact to enable a position control of the entire load, in a preferred embodiment of the device according to the invention, it is provided that a plurality of actuators is provided for a plurality, preferably for at least three, especially preferably for all, groups. This means that the actuators are operatively connected with the elastic elements, or their second end regions, where not all of said elastic elements belong to the same group, rather at least partly they belong to different groups. Said groups should not be attached along a straight line on the base element, but rather should spread over an area that is as large as possible.

One actuator can also be connected to elastic elements of a plurality of groups, i.e., individual actuators can also be provided for more than one group. Basically, each actuator can also be associated with just one group, so as to be able to affect the position of the load. If movable elastic elements are present in all groups, a position control is possible in any case. In particular, then the entire base element—and with it the load—can be adjusted in height with respect to at least one fixed point, in particular with respect to a floor, which is also called the height position in what follows.

In order to be able set or change completely the position, in the sense of the orientation and level of the load, movable elastic elements must be present in at least three groups, where the vertical positions of the second end regions of said elastic elements can be moved independent of each other by means of actuators and where the relevant first end regions of the elastic elements of said at least three groups—or the corresponding attachment regions—spread out over a plane. In this way, for example, a position compensation, which becomes necessary due to a change of the distribution of weight of the load or due to aging phenomena in the elastic elements, is easily possible. It should be noted that just two actuators are sufficient to be able to always guarantee a perfectly horizontal orientation. If the height/level is also to be settable, three actuators are necessary.

In practice, it is often advantageous to provide four attachment regions, which can be disposed, for example, in the form of a rectangle with respect to each other, in order to ensure easy access to the suspended load. Thus, in a preferred embodiment of the device according to the invention, it is provided that at least three, preferably four, attachment regions are provided.

In correspondence with the above, in a preferred embodiment of the device according to the invention, it is provided that exactly three actuators are provided. Because said actuators are operatively connected to the second end regions of movable elastic elements, which belong to groups whose attachment regions span a plane, a desired orientation of the load, in particular a perfectly horizontal orientation, can be set through the corresponding control of the individual actuators.

If still other attachment regions, whose groups have movable elastic elements, are present, it is conceivable to associate said movable elastic elements with one or more of the three actuators, so as to enable a level regulation in addition to setting the orientation. Said actuators will possibly need to be dimensioned appropriately larger in each case according to how many additional elastic elements are operatively connected to the individual actuators.

In order to be able to suspend especially large loads of 1000 kg or more with the device according to the invention and in doing so to be able to set the orientation and/or height position of the load, in a preferred embodiment of the device according to the invention it is provided that, in each case, two to twenty elastic elements are provided per group, where exactly one elastic element per group is operatively connected to the at least one actuator. This includes the case where twenty elastic elements are provided per group. Such an embodiment, for example with nine elastic elements per group and four groups or end regions, has proven itself in practice.

Basic possibilities as elastic elements are, for example, the substantially known tension springs, especially ones made of metal. Rubber cords, which typically have a soft, yielding, and dissipative core and a less elastic jacket can be used for this. Examples of such rubber cords with said construction are known from various areas of technology. For example, such rubber cords are used in many areas, even in the home, as elastic straps. In particular, such rubber cords with said construction are known as bungee cords and are commercially available.

Rubber cords or bungee cords have a number of advantages over metal springs. For one thing, the weight of rubber cords or bungee cords is typically less than the metal springs that may be used that have the same spring constant and resilience, which has as a result the comparably higher resonance frequencies of a single rubber cord. The extension characteristic, given by the derivative of the force F over the elongation x, dF/dx, is especially advantageous in the case of rubber cords or bungee cords in that very low resonance frequencies are the result in the extension region typically achieved in the intended use. Also, one can match the cords to the suspended load or the burden, so that they are used in a region of their force-distance characteristic where the change of the three with elongation is as low as possible, i.e., where the cords are as soft as possible and a low resonance frequency results. Typically, said extension range lies between 20% and 80% elongation.

Moreover, a damping of resonances of the suspended load on the one hand and of the characteristic modes, for example the vibrations of the individual rubber cords or bungee cords, on the other hand results from the material property. Said damping is clearly better with rubber cords than with pure metal springs.

Therefore, in a preferred embodiment of the invention, it is provided that the elastic elements comprise rubber cords, in particular bungee cords, and are preferably formed entirely by rubber cords, in particular bungee cords. Theoretically, it would also be conceivable to combine the rubber cords or bungee cords with other elastic elements. For example, only a part of the elastic elements could be formed by rubber cords or bungee cords and the remainder of the elastic elements could be formed by springs, in particular metal springs. In addition to this theoretical possibility of a kind of parallel circuit of rubber cords and springs, a kind of series circuit would above all also be conceivable, where rubber cords—or more generally elements of rubber or elastomer materials—and springs are connected one behind the other. The rubber cords—or elements of rubber or elastomer materials—could in this case take on, in particular, a damping function because of their material properties.

In view of said damping properties, it can generally be said that especially elastic elements, whose material is both elastic and also dissipative or which have a combination of such materials, suggest themselves. Thus, in a preferred embodiment of the device according to the invention, it is provided that the elastic elements are made so that they have a dissipative behavior. Theoretically, this could also be realized, for example, by a combination of a metal spring with a damping element.

In a preferred embodiment of the device according to the invention, it is provided that the at least one actuator is formed by at least one gear motor. Preferably, all actuators are formed by gear motors. Such actuators allow a simple and cheap construction of the device according to the invention. Basically, of course, other actuators are also conceivable, for example a combination of an electric motor or gear motor with a threaded spindle or a hydraulic cylinder or a pneumatic cylinder.

In order to be able to move or adjust the vertical position of the second end region of various elastic elements with the at least one gear motor in the operating state, in a preferred embodiment of the device according to the invention, it is provided that for operative connection between the at least one gear motor and the second end region of the at least one elastic element, a belt is attached to the second end region of the relevant elastic element in each case and that a spool, which is connected to the at least one gear motor and can be driven by it, is provided for the relevant belt so as to wind the relevant belt onto the relevant spool and/or to unwind the belt from the spool. The wording “and/or” is to be understood to mean that it can be both unwound and wound, where the winding and unwinding of the same belt obviously does not take place simultaneously.

In order to be able to undertake an at least rough adjustment of the length to the relevant use, in particular the load, even in the case of the fixed elastic elements, in a preferred embodiment of the device according to the invention, it is provided that adjustment elements are provided in order to be able to set a length of the elastic elements, preferably manually, where the adjustment elements are preferably provided only for those elastic elements that are nit in operative connection with the at least one actuator. Such adjustment elements are basically known. Said adjustment elements can be formed, for example, as cable clamps for rubber cords or as threaded spindles for metal springs. Of course, the adjustment elements can also be provided in the case of the movable elastic elements.

In a preferred embodiment of the device according to the invention, it is provided that at least one position sensor, preferably an inductive position sensor, is provided in order to determine the position of the base element and/or the load by processing measurement signals of the at least one position sensor by means of the regulating and control unit, where preferably three position sensors are provided. Inductive position sensors, in particular distance sensors, are substantially known and are commercially available at low cost.

The at least one position sensor can be disposed on the base element or directly on the load or on a fixed point.

In an especially preferred embodiment of the device according to the invention, it is provided that at least one distance sensor is provided in order to determine a distance to at least one fixed point in operating state and thus to be able to detect an incorrect position of the base element and/or the load, where preferably three distance sensors are provided.

The distance sensor thus serves to determine a distance between the fixed point and the base element and/or the load. Basically, the distance sensor measures the distance between it and the fixed point (if the distance sensor is disposed on the base element and/or the load) or the base element or the load (if the distance sensor is disposed at the fixed point). Indirectly, of course, the distance between the base element and/or the load to the fixed point is also determined by this. If the geometry is known, a horizontal distance, fir example, can be employed to detect a tipping of the base element/the load. To be able to detect an erroneous level (height) of the base element/load, preferably at least one vertical distance is measured.

By detecting an incorrect position of the base element, an incorrect position of the load can clearly also be directly detected with high precision.

As already noted, an incorrect position can be the result of an altered weight distribution of the load or of aging phenomena of the elastic elements. For example, rubber cords or bungee cords lose their elasticity over time. According to the specific type of rubber cord or bungee cord that is used in each case, the aging can result in, for example, an approximately 25% reduction of the elasticity over a period of 10 years.

Based on the misorientation that is found, the actuators can be appropriately controlled—in particular by means of the position sensors, the measurement signals of which are processed by the regulating and control unit—so as to again produce the desired position of the base element or the load. Care should be taken that unnecessary vibrations or oscillations of the load are not caused due to the adjustment by the actuators. Therefore, in a preferred embodiment of the device according to the invention, it is provided that a speed with which the vertical position of the second end region of the at least one elastic element can be changed in the operating state can be controlled and regulated by the regulating and control unit. Preferably, the control unit in this case is designed as a proportional controller with play. This means that there is a small region around the set value—for example when vertical distances are measured with distance sensors, then there is a small region around said value(s) of the vertical distances—in which the actuators, in particular gear motors, do not begin to operate, or do not start up.

Optionally, a low pass filter, the limit frequency of which lies below the resonance frequency of the load at the suspension (i.e., under the resonance frequency of the system of the device according to the invention and the load suspended with it), can additionally be provided in the regulating and control unit. If the corresponding oscillations of the load occur, this keeps the actuators from causing unnecessary movements of the elastic elements and thus possibly magnifying the oscillations even further.

As already mentioned, the regulating and control unit is designed so as to enable an automatic readjustment of the desired orientation and/or height or an automatic position control of the base element/the load in the operating state, i.e., so as to keep the orientation or position of the base element/load constant. Usually, the preset orientation will be horizontal or such that the load is horizontally oriented. However, there may also be cases where a certain tipping of the load relative to the horizontal plane is desired and thus should be intentionally maintained, i.e., kept constant. The regulating and control unit in this case is connected to the position sensors, in particular distance sensors, and processes their measurement signals or measurement data in order to compensate any detected incorrect orientation of the load or the base element.

It should be noted that the number of position sensors and the number of actuators does not unconditionally need to be the same. This circumstance can be taken into account by designing the regulating and control unit as a multi-parameter controller (also called a MIMO controller, where MIMO stands for “multiple input/multiple output”). In this case, linear combinations of the sensor signals are used to control the actuators. Moreover, if the number of position sensors and actuators is the same, the sensor signal of a position sensor may not be assigned “directly” to an actuator. For example, this can be the case with position sensors that are disposed in regions other than the attachment regions.

In order to further improve the performance of the device according to the invention with respect to vibration isolation, an active vibration isolation can additionally be provided. In this case, said additional active vibration, isolation need not bear the load and thus can be correspondingly weak. Correspondingly, in a preferred embodiment of the device according to the invention, it is provided that at least one vibration sensor is provided in order to be able to detect vibrations of the base element and/or the load in the operating state and that at least one additional actuator, in particular one formed by a moving coil, which is disposed between at least one fixed point and the base element and is connected to the base element, is provided, in order to compensate the oscillations of the base element and/or the load that are determined.

Typically, a plurality of vibration sensors and a plurality of additional actuators can be used. For example, it is possible to provide at least one vibration sensor for each degree of freedom of the base element or the load. Moreover, for each degree of freedom of the base element or the load, one or more additional actuators can be provided. In particular, for three points/regions of the base element or the load, three additional actuators (one per spatial direction) can be provided, thus a total of nine additional actuators.

Suitable vibration sensors are substantially known, where, for example, seismometers or acceleration sensors, Which are also called accelerometers or G sensors, can be used. The at least one vibration sensor is preferably attached to the base element and/or the load or is directly connected to the base element and/or the load. Since vibrations of the base element can be detected, vibrations of the load can also be directly detected. Suitable moving coils are likewise substantially known; they are also called, among other things, “voice coils.”

Theoretically, the regulating and control unit can be designed to additionally process the signals of the at least one vibration sensor and to control the at least one moving coil or to appropriately control the at least one moving coil or the at least one additional actuator. Preferably, however, an additional regulating and control unit is provided, which unit evaluates the data of the at least one vibration sensor and appropriately controls the at least one additional actuator. One can also fall back on substantially known algorithms for the appropriate control.

Analogous to the above, according to the invention, a system comprising a load, which is suspended on at least one support element by means of a device according to the invention, is also provided. The device according to the invention in this case is preferably in an operating state.

In a preferred embodiment of the system according to the invention, it is provided that the elastic elements are formed by rubber cords, in particular bungee cords, where in each group at least one rubber cord runs so that it includes an angle with the vertical that is not equal to 0°, preferably an angle in the range of 3° to 30°. This reduces the Q factor for (horizontal) pendulum vibrations, the damping of which otherwise turns out to be clearly less, since vertical rubber cords or bungee cords essentially do not change their length in the case of pendulum vibrations.

In order to reduce the Q factor for pendulum vibrations especially strongly, in an especially preferred embodiment of the system according to the invention, it is provided that at least half of the rubber cords of each group run so that the rubber cords include an angle with the vertical that is not equal to 0°, preferably an angle in the range of 3° to 30°.

### BRIEF DESCRIPTION OF THE FIGURES

The invention will now be explained in more detail by means of embodiment examples. The drawings are examples and are intended to present the ideas of the invention but not to restrict it in any way or even to conclusively reproduce it.

Here:

FIG. 1 shows a schematic side view of an embodiment of a device according to the invention in an operating state

FIG. 2 shows a schematic side view of another embodiment of the device according to the invention in an operating state, where, compared to the embodiment example in FIG. 1, an additional active vibration isolation is implemented

FIG. 3 shows a schematic detailed view of an operative connection between an actuator and an elastic element of the devices according to the invention from FIG. 1 and FIG. 2.

### WAYS TO IMPLEMENT THE INVENTION

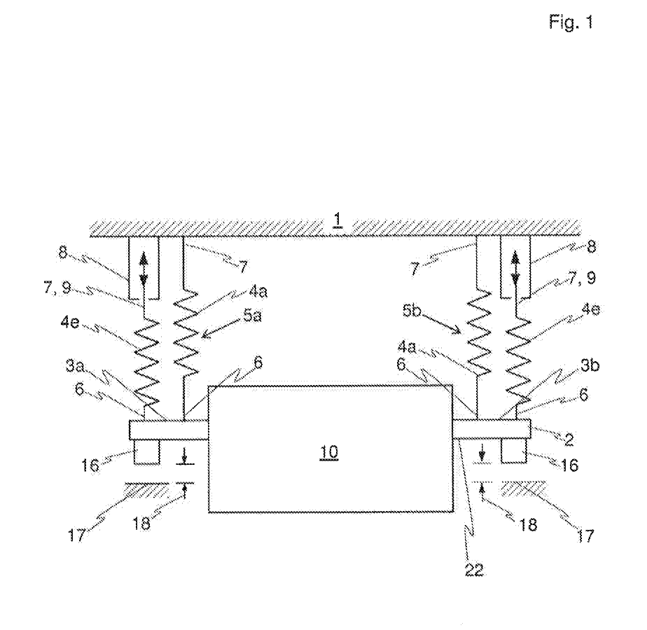

FIG. 1 shows an embodiment of a device according to the invention for vibration-isolated suspension of a load 10 in a schematic side view. The load 10 in this case is suspended from a support clement 1, which in FIG. 1 is formed by a ceiling of a space.

The device is shown in an operating state.

The device and the load 10 suspended on the support element 1 by means of the device are part of a system according to the invention.

To accept the load 10, the device comprises a base element 2, which in this example is formed by a frame, which is connected to at least two sides of the load 10, for example by screw connections.

In the embodiment example shown, the base element 2 has four attachment regions—one each in a corner region of the base element 2, where the corner regions are disposed with respect to one another in the form of a rectangle, where, in the side view in FIG. 1, only two attachment regions 3a and 3b are visible. In each case, three among all of the attachment regions spread over a plane. Unless otherwise explicitly indicated, in what follows, a reference to the attachment regions 3a, 3b implies a reference to all four attachment regions.

A group 5a, 5b—thus a total of four groups is present—in each case, of a plurality of elastic elements, is associated with each attachment region 3a, 3b, where for clarity only two elastic elements are drawn per group 5a, 5b in FIG. 1. There could, however, also be more elastic elements, for example nine, per group 5a, 5b.

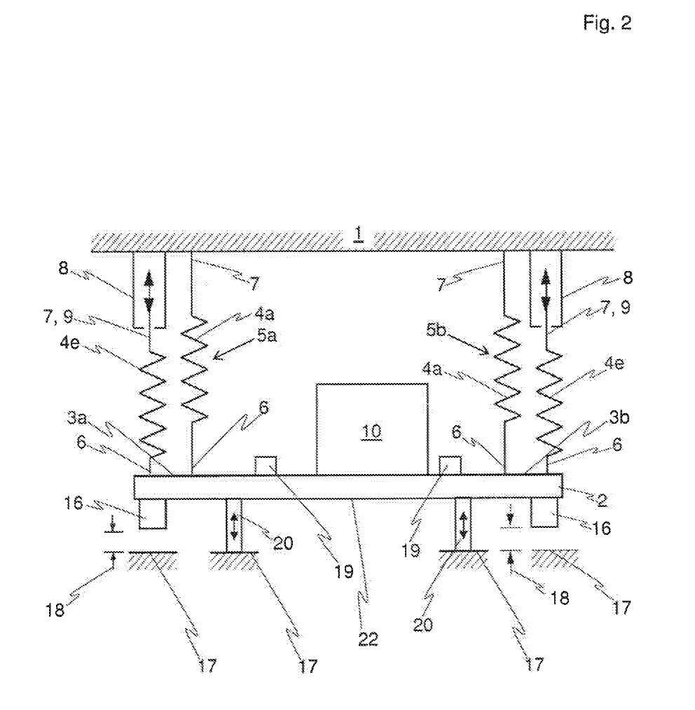

The elastic elements are formed by rubber cords 4a, 4e, whose structure essentially corresponds to that of bungee cords and which are commercially available. To emphasize their elastic properties, the rubber cords 4a, 4e are shown by zigzag lines in FIGS. 1 and 2.

Each of rubber cords 4a, 4e has a first end region 6, by which the rubber cords 4a, 4e are connected to the base element 2 in the attachment regions 3a, 3b. Here, adjustment elements (not shown) can be provided for attachment in order to be able to set a length of the rubber cords 4a, 4e. The adjustment elements in this case can be formed, for example, as clamps.

In addition, the rubber cords 4a, 4e have a second end region 7, which is provided for attachment to the support element 1. Correspondingly, the rubber cords 4a, 4e basically connect the attachment regions 3a, 3b or the base element 2 to the support element 1. In FIG. 1, the second end regions 7 of the rubber cords 4a are connected directly to the support element 1.

The second end region 7 of the rubber cords 4e, on the other hand, are operatively connected to actuators, which are formed by gear motors 8. In FIG. 1, each of the rubber cords 4e is provided with its own gear motor 8, where the gear motors 8 can be controlled independent of each other by means of a regulating and control unit (not shown).

Thus, a vertical position 9 of the second end region 7 of the rubber cord 4e which is operatively connected to the gear motor 8 can be moved or adjusted with each of the gear motors 8, which in turn are connected to the support element 1.

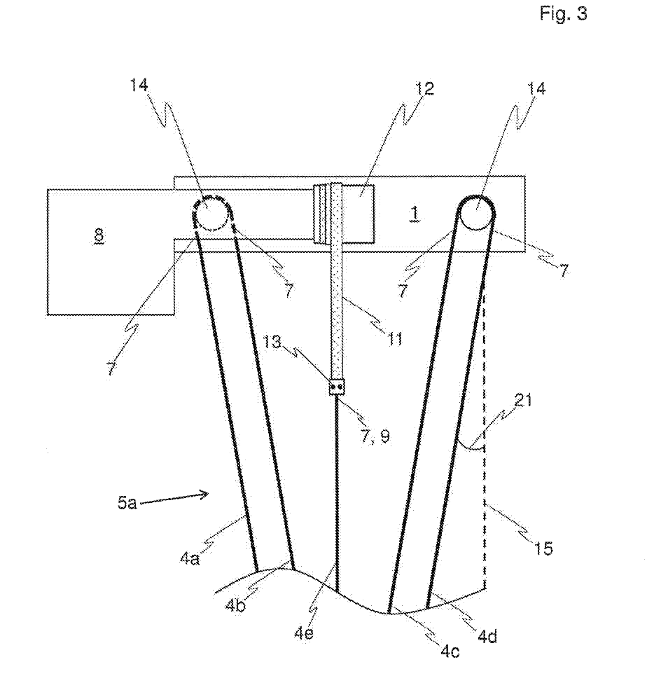

FIG. 3 schematically illustrates such an operative connection between gear motor 8 and rubber cord 4e of group 5a in a detailed view, where in this case the support element 1 is formed by a steel beam, which in turn can be mounted, for example, on the ceiling. The gear motor 8 is connected to the support element 1, for example by screw connections.

In FIG. 3, another three rubber cords 4b, 4c, 4d are drawn in addition to the rubber cords 4a, 4e. Even more elastic elements can also be provided. For example, another four rubber cords, which. are formed like the rubber cords 4a, 4b, 4c, 4d and are attached to support 1, can also be provided. However, said cords would be disposed in a direction normal to the plane of the drawing and projecting outward from the plane of the drawing looking toward the rubber cords 4a, 4b, 4c, 4d, 4e, and therefore are not shown in FIG. 3.

In the embodiment example shown, the rubber cords 4a, 4b are formed by segments of a single rubber cord, which runs on a return roller 14, which is attached to support element 1. Said return roller 14 is hidden by the gear motor 8 in FIG. 3 and therefore is drawn with a dashed line, as are the segments of the rubber cords 4a, 4b that are hidden by the gear motor 8. The rubber cords 4c, 4d are similarly formed by segments of a single rubber cord, which runs on a return roller 14, which likewise is attached to support element 1. The return oilers 14 are bearing-mounted on support element 1.

A belt 11, which, by means of the gear motor 8, can be unwound from a spool 12, which is connected to the gear motor 8 and can be driven by it, or can be rolled up onto said spool 12, is provided for operative connection with the second end region 7 of the rubber cord 4e. The belt 11 is connected to the second end region 7 of the rubber cord 4e by means of a connecting element 13, which in particular can be made as a clamp. Correspondingly, the vertical position 9 of the second end region 7 of the rubber cord 4e is changed by the winding and unwinding of belt 11.

Per group 5a, 5b, therefore, only the relevant rubber cord 4e is moved by the gear motors 8. The embodiment examples of the device that are shown are designed here so that the rubber cords 4a, 4b, 4c, 4d—or each rubber cord that is not operatively connected to the gear motors 8, i.e., all rubber cords except for the rubber cords 4e—by themselves are insufficient to be able to support or suspend on support element 1 the load 10 together with base element 2. This means that without the rubber cords 4e, the base element 2 would lie on the floor or other fixed points 17 and not be lifted, or, in other words, distances 18 between the fixed points 17 and inductive distance sensors 16 that are mounted on an underside 22 of the base element 2 would be less than the relevant said values. Only through the additional elasticity of the rubber cords 4e will the weight of the load 10 and base element 2 be overcome and in the operating state an actual suspension of the load 10 can take place so that the distances 18 correspond to the desired set values. Then, by the vertical positions 9 of the second end regions 7 of the rubber cords 4e being lifted or lowered by the drive motors 8, the base element 2 together with load 10 in the region of the attachment regions 3a, 3b becomes lifted or lowered. Correspondingly, the gear motors 8 can be dimensioned to be correspondingly low-power, which again saves costs. Moreover, experience shows that said comparably small or low-power gear motors 8 themselves produce less vibration than larger or more powerful gear motors 8. Further, the vibrations of each gear motor 8 can only be transferred by one of the rubber cords 4, where the transfer of force to the load 10 is clearly less if the force transfer were to take place through all of the rubber cords 4a, 4b, 4c, 4d, 4e. For this reason, the starting, for example, of the gear motors 8 is correspondingly unproblematic.

Specifically, for example, for vibration-isolated suspension of a load 10 of about 1000 kg with a base element 2 of about 100 kg, rubber cords that have an elongation of around 30% at an engaged (weight) force of 300 N and thus operate in a recommended extension range of 20% to 80% can be used without problem if four groups 5a, 5b of nine rubber cords 4a, 4b, 4c, 4d, 4e, each 2 m long, are provided. in this way, (vertical) resonance frequencies of the system that lie in the range of 0.8 Hz can be realized. The load 10 is isolated against vibrations in the vertical direction, i.e., parallel to the verticals 15 (see FIG. 3), correspondingly well.

In order to produce a certain damping of horizontal—thus normal to the vertical 15—pendulum vibrations, too, all of the rubber cords in each group 5a, 5b in the embodiment example shown, with the exception of the rubber cord 4e, which is operatively connected to the gear motor 8, are disposed at an angle to the vertical line 15. Correspondingly, the rubber cords 4a, 4b, 4c, 4d in FIG. 3 include an angle 21 with the vertical line 15 which is not equal to 0°, which is preferably in the range of 3° to 30°. In this way, the Q factor of the system for pendulum vibrations is reduced.

Three distance sensors 16, which are disposed in the region of the attachment regions 3a, 3b on the underside 22 of the base element 2, are provided in the embodiment examples shown. In the region of the attachment regions 3a, one of the three distance sensors 16 is centrally disposed between the two attachment regions 3a on the base element 2. The other two distance sensors 16 are each disposed in the region of one of the two attachment regions 3b. However, in each case, only two of the distance sensors 16 are visible in FIGS. 1 and 2 because of the schematic side view.

The distance sensors 16 measure the distance 18 between the relevant distance sensor 16 and the associated fixed point 17, whereby through this a distance between the base element 2 and the relevant fixed point 17 is of course also determined. Correspondingly, the position, in particular the orientation and the (vertical) level, or a possible incorrect position of the base element 2 and thus of the load 10 can also be detected, where in the embodiment example shown, a rotation about the vertical line 15 is not detected.

Since in each case a rubber cord 4e that can be moved by one of the gear motors 8 is provided for each attachment region 3a, 3b, the position can be set as desired and incorrect positions can be compensated immediately and with high precision in order to keep the desired position of the base element 2 or the load 10 constant. For this, the regulating and control unit evaluates the measurement signals or measurement data of all of the distance sensors 16 continuously and correspondingly controls the gear motors 8 if an incorrect position of the base element 2 or the load 10 is detected so as to reestablish the desired position. Specifically, all gear motors 8 are controlled so that the distances 18 take values that correspond to a desired orientation at a desired (vertical) level of the base element 2 or the load 10 with respect to the fixed points 17, which in particular can be disposed on the floor. Typically, the relevant distance 18 is relatively small in practice, for example in the range of 1 mm to 10 mm. Consequently, therefore, an automatic position control is achieved.

In order to further improve the performance of the device according to the invention or the system according to the invention with respect to vibration isolation, an active vibration isolation can additionally be provided, as illustrated in FIG. 2. Said additional active vibration isolation does not need to bear the load 10 and therefore can be sized to be correspondingly low-power.

In the embodiment example shown, a plurality of vibration sensors 19 is provided in order to be able to detect vibrations of the base element 2 and thus the load 10, whereby in FIG. 2, two vibration sensors 19 are shown. Said vibration sensors 19 are mounted directly on the base element 2 and can, for example, each be formed by a seismometer or accelerometer,

Further, additional actuators are provided in order to compensate the detected vibrations of the base element 2. In the embodiment example shown, the additional actuators are formed by moving coils 20, where in FIG. 2, two moving coils 20 are shown. The moving coils 20 are each disposed between a fixed point 17, which can be a part of the floor, and the base element 2 and are connected with it. The connection of course is not rigid, as is indicated in FIG. 2 by the double arrow at the moving coils 20.

The measurement signals or measurement data of the vibration sensors 19 are preferably evaluated by an additional regulating and control unit (not shown). The additional regulating and control unit hereupon correspondingly controls the moving coils 20 in order to compensate the detected vibrations of the base element 2 and thus the load 10.

Apart from the active vibration isolation, in FIG. 2, the base element 2 is made not as a frame, but rather as a platform, on which the load 10 is disposed. The design of the base element 2 is basically not dependent here on the presence of an additional active vibration isolation. I.e., a base element 2 in the form of a platform is also possible without additional active vibration isolation; likewise a base element 2 in the form of a frame is possible if an additional active vibration isolation is present.

### REFERENCE LIST

1 Support element
2 Base element
3a, b Attachment region
4a, b, c, d, e Rubber cord
5a, b Group of rubber cords
6 First end region of rubber cord.
7 Second end region of rubber cord
8 Gear motor
9 Vertical position
10 Load
11 Belt
12 Spool
13 Connection element
14 Roller
15 Vertical
16 Distance sensor
17 Fixed point
18 Distance between distance sensor and fixed point
19 Vibration sensor
20 Moving coil
21 Angle
22 Underside of base element

1. Device for vibration-isolated suspension of a load (10) on at least one support element (1), the device comprising a base element (2) for accepting the load (10), where the base element (2) comprises a plurality of attachment regions (3a, 3b) for attachment of elastic elements (4a, 4h, 4c, 4d, 4e), where each of the elastic elements (4a, 4b, 4c, 4d, 4e) has a first end region (6) and a second end region (7) and is attached by the first end region (6) to the base element (2), where the second end region (7) of the relevant elastic element (4a, 4b, 4c, 4d, 4e) is provided for its attachment to the at least one support element (1), characterized in that a regulating and control unit and at least one actuator (8) are provided in order to regulate in an operating state of the device a preferably settable position of the base element (2) and/or the load (10), where the at least one actuator (8) is operatively connected to the second end region (7) of at least one elastic element (4e), in order to be able to adjust a vertical position (9) of the second end region (7) of said at least one elastic element (4e).

2. Device as in claim 1, characterized in that a group (5a, 5b), which comprises a plurality of the elastic elements (4a, 4b, 4c, 4d, 4e), is provided for each attachment region (3a, 3b), in order to connect the relevant attachment region (3a, 3b) to the at least one support element (1), and that the at least one actuator (8) is operatively connected to the second end region (7) of at least one elastic element (4e) of at least one of the groups (5a, 5b).

3. Device as in claim 2, characterized in that a plurality of actuators (8) are provided for a plurality, preferably for at least three, especially preferably for all, groups (5a, 5b).

4. Device as in one of claims 2 to 3, characterized in that at least for one, preferably for at least three, especially preferably for each of the groups (5a, 5b), a number of each elastic elements (4e) of said group (5a; 5b), which are operatively connected to the at least one actuator (8), is less than a total number of the elastic elements (4a, 4b, 4c, 4d, 4e) of said group (5a; 5b).

5. Device as in claim 4, characterized in that the number is a maximum of one.

6. Device as in one of claims 1 to 5, characterized in that at least three, preferably four, attachment regions (3a, 3b) are provided.

7. Device as in one of claims 2 to 6, characterized in that, in each case, two to twenty elastic elements (4a, 4b, 4c, 4d, 4e) are provided per group (5a, 5b), where exactly one elastic element (4e) per group (5a, 5b) is operatively connected to the at least one actuator (8).

8. Device as in one of claims 1 to 7, characterized in that exactly three actuators (8) are provided.

9. Device as in one of claims 1 to 8, characterized in that the elastic elements (4a, 4b, 4c, 4d, 4e) are designed so that they have a dissipative behavior.

10. Device as in to claim 9, characterized in that the elastic elements comprise rubber cords (4a, 4b, 4c, 4d, 4e), in particular bungee cords, and preferably are formed entirely by rubber cords (4a, 4b, 4c, 4d, 4e), in particular bungee cords.

11. Device as in one of claims 1 to 10, characterized in that the at least one actuator is formed by at least one gear motor (8).

12. Device as in claim 11, characterized in that for operative connection between the at least one gear motor (8) and the second end region (7) of the at least one elastic element (4e), in each case, a belt (11) is attached to the second end region (7) of the relevant elastic element (4e), and a spool (12), which is connected to the at least one gear motor (8) and can be driven by it in order to wind the relevant belt (11) onto the relevant spool (12) and/or to unwind it from said spool, is provided for the relevant belt (11).

13. Device as in one of claims 1 to 12, characterized in that adjustment elements are provided in order to be able to set a length of the elastic elements (4a, 4b, 4c, 4d, 4e), preferably manually, where the adjustment elements are preferably provided only for those elastic elements (4a, 4b, 4c, 4d) that are not in operative connection to the at least one actuator (8).

14. Device as in one of claims 1 to 13, characterized in that at least one, preferably inductive, position sensor (16) is provided in order to determine the position of the base element (2) and/or the load (10) by processing measurement signals from the at least one position sensor by means of the regulating and control unit, where preferably three position sensors (16) are provided.

15. Device as in claim 14, characterized in that at least one distance sensor (16) is provided as at least one position sensor in order to determine, in the operating state, a distance (18) to at least one fixed point (17) and thus to be able to detect an incorrect position of the base element (2) and/or the load (10), where preferably three distance sensors (16) are provided.

16. Device as in one of claims 1 to 15, characterized in that a speed with which in operating state the vertical position (9) of the second end region (7) of the at least one elastic element (4e) can be changed can be controlled and regulated with the regulating and control unit.

17. Device as in one of claims 1 to 16, characterized in that at least one vibration sensor (19) is provided in order to be able to detect, in the operating state, vibrations of the base element (2) and/or the load (10), and that at least one additional actuator is provided, especially one formed by a moving coil (20), the actuator being disposed between at least one fixed point (17) and the base element (2) and being connected to it, in order to compensate the detected vibrations of the base element (2) and/or the load (10).

18. System comprising a load (10), which is suspended on at least one support element (1) by means of a device as in one of claims 1 to 17.

19. System as in claim 18, characterized in that the elastic elements are formed by rubber cords (4a, 4b, 4c, 4d, 4e), in particular bungee cords, where in each group (5a, 5b), at least one rubber cord (4a, 4b, 4c, 4d) runs so that it includes an angle (21) with the vertical line (15) that is not equal to 0°, preferably an angle (21) in the range of 3° to 30°.

20. System as in claim 18, characterized in that half of the rubber cords (4a, 4b, 4c, 4d) of each group (5a, 5b) run so that the rubber cords (4a, 4b, 4c, 4d) include an angle (21) with the vertical line (15) that is not equal to 0°, preferably an angle (21) in the range of 3° to 30°.
